(19) United States
(12) Patent Application Publication
(10) Pub. No.: US 2025/0286419 A1
(43) Pub. Date: Sep. 11, 2025

(54) ROTOR STRUCTURE

(71) Applicant: MCF Electric Drive Corporation, Hiroshima City, Hiroshima (JP)

(72) Inventor: Naoki ITASAKA, Hiroshima City (JP)

(21) Appl. No.: 18/967,048

(22) Filed: Dec. 3, 2024

(30) Foreign Application Priority Data
Mar. 5, 2024 (JP) 2024-033421

(51) Int. Cl. H02K 1/32; H02K 1/276; H02K 1/30; H02K 7/00; H02K 9/193

(52) U.S. Cl. CPC H02K 1/32; H02K 1/276; H02K 1/30; H02K 7/003; H02K 9/193

(57) ABSTRACT

A rotor structure that supplies an oil to a cooling target part inside a synchronous motor in which a rotor rotates in synchronization with a rotating magnetic field generated by a stator, being configured such that the rotor comprises a plurality of permanent magnets, which are one of the cooling target parts, and a cylindrical rotor core in which a plurality of axially extending magnet holes are formed in which the respective permanent magnets are embedded, and an oil flows axially inside the rotor core through the plurality of magnet holes.

### CROSS-REFERENCE TO RELATED APPLICATIONS

This application is based on Japanese Application No. 2024-33421 filed on Mar. 5, 2024, the contents of which are incorporated herein by reference.

### BACKGROUND OF THE INVENTION

### Field of the Invention

The present invention relates to a rotor structure, and more particularly to a rotor structure for supplying an oil to a cooling target part inside a synchronous motor.

### Background of the Disclosure

As electric vehicles become more widespread, there is a demand for the motors that drive them to be easier to install and more productive, easier to deploy in a wide range of vehicle models, and cheaper to manufacture, and to achieve these goals, there is a demand to reduce the size of the motor while maintaining its output, in other words, to increase the output density of the motor.

In order to increase the output density of a motor, it is unavoidable to increase the density of the current flowing through the stator coil, however, increasing the current density in a synchronous motor increases the amount of heat generated by the permanent magnets, causing the temperature of various parts inside the motor to rise, therefore, in some cases, this may lead to demagnetization of the permanent magnets and ultimately a decrease in motor torque.

Then, in order to cool permanent magnets inside a rotor core, for example, JP-A No. 2014-176235 discloses a rotor for a rotating electric machine in which a coolant flow passage extending in the axial direction is provided near the magnets housed in the rotor core.

In a motor, the rotor core itself generates heat, and in a configuration in which the cooling target part (permanent magnet) is cooled by a coolant (cooling oil) supplied to a coolant flow path provided near the cooling target part, as in the above-mentioned JP-ANo. 2014-176235, the cooling oil may rise in temperature due to heat exchange with the rotor core before the cooling target part is cooled, which may result in insufficient cooling of the cooling target part. Therefore, the configuration in JP-A No. 2014-176235 leaves room for improvement in terms of efficient cooling of the cooling target part inside the motor.

The present invention has been made in consideration of the above-mentioned points, and an object of the present invention is to provide a rotor structure capable of efficiently cooling the cooling target part inside a synchronous motor.

### SUMMARY

In order to achieve the above object, in a rotor structure according to the present invention, the permanent magnets embedded in the rotor are directly cooled by an oil.

Specifically, the present invention is directed to a rotor structure that supplies an oil to a cooling target part inside a synchronous motor in which a rotor rotates in synchronization with a rotating magnetic field generated by a stator.

This rotor structure is characterized by being configured such that: the rotor comprises a plurality of permanent magnets, which are one of the cooling target parts, and a cylindrical rotor core in which a plurality of axially extending magnet holes are formed in which the respective permanent magnets are embedded, and an oil flows axially inside the rotor core through the plurality of magnet holes.

According to this configuration, an oil flows axially inside the rotor core through the magnet holes in which the permanent magnets are embedded, and the oil can directly cool the permanent magnets, which are one of the cooling target parts. This makes it possible to cool the permanent magnets, which are one of the cooling target parts, more efficiently than, for example, a structure in which an oil flows in holes (oil passages) provided near the permanent magnets in the rotor core.

By the way, when an oil is sent to the rotor, it is common to send the oil from an oil passage provided in the rotor shaft, but if a configuration is adopted in which the oil passage in the rotor shaft is directly connected to the magnet holes, it is assumed that there will be variations in the amount of an oil supplied to the magnet holes. If such variations in the amount of an oil occur, some of the multiple permanent magnets embedded in the rotor core will not be sufficiently cooled, and some of the permanent magnets may be demagnetized, resulting in a decrease in torque.

Therefore, the rotor structure described above may be configured such that: the rotor further comprises a rotor shaft that is inserted into the rotor core so as not to rotate relative to the rotor core, and an annular one-side end plate that is attached concentrically with an axis center of the rotor core to the end on one axial side of the rotor core, the one-side end plate has a chamber space formed having an annular shape as viewed in the axial direction concentrically with the axis center of the rotor core, and at the one-side end plate, an oil is filled into the chamber space from an oil passage in the rotor shaft and the oil is distributed from the chamber space to the plurality of magnet holes.

According to this configuration, rather than sending an oil directly from the oil passage in the rotor shaft to the magnet holes, the oil is first filled into the chamber space formed in the one-side end plate, and then the oil is distributed from the annular chamber space to the plurality of magnet holes, allowing the oil to be evenly supplied to the plurality of magnet holes formed in the rotor core.

In addition, the oil distributed to the magnet hole is only filled into the chamber space once, and is supplied to the magnet hole in a sufficiently cooled state, rather than after cooling the rotor core, etc. (raising the temperature), so that the oil can effectively cool the permanent magnets.

As a result, it is possible to prevent some of the permanent magnets from being cooled insufficiently, and therefore it is possible to reliably prevent the permanent magnets from being demagnetized, and ultimately, to prevent a decrease in torque.

Furthermore, in the rotor structure described above, it may be permissible that the one-side end plate has a plurality of radial oil passages formed that extend radially on an other axial side than the chamber space, whose radially inner end communicates with the chamber space, and whose radially outer end communicates with a plurality of the magnet holes, and in each of the radial oil passages, a surface that defines the radial oil passage on one axial side and a surface that defines the radial oil passage on the radially outer side are connected in an R-shape when viewed in a circumferential direction.

According to this configuration, a plurality of radial oil passages are formed, extending radially on the other axial side than the chamber space (the side closer to the rotor core), with their radially inner ends communicating with the chamber space and their radially outer ends communicating with the plurality of magnet holes, therefore, the oil filled in the chamber space can be evenly distributed to the plurality of magnet holes through these multiple radial oil passages.

Here, an oil flows radially outward in the radial oil passage, while flows axially when supplied to the magnet hole, and in a structure in which if a surface that defines the radial oil passage on one axial side (referred to as the “first defining surface”) and a surface that defines the radial oil passage on the radially outer side (referred to as the “second defining surface”) are perpendicular to each other, it is also assumed that the oil will not change direction smoothly. In addition, during motor operation when the need for cooling is high, the rotor is constantly rotating and centrifugal force acts on the oil, so the oil that flows radially in the radial oil passage is easily pressed against the second defining surface, and it is assumed that in a structure in which the first defining surface and the second defining surface are perpendicular to each other, it will be even more difficult for the oil to change direction.

In this regard, the first defining surface and the second defining surface are connected in an R-shape when viewed in the circumferential direction, in this configuration, so that when the oil that flows radially outward through the radial oil passage under centrifugal force is supplied to the magnet hole, a smooth change of direction in the axial direction can be achieved, thereby making it possible to more efficiently cool the permanent magnet, which is the cooling target part.

Furthermore, in the rotor structure described above, it may be permissible that the one-side end plate has a plurality of radial oil passages formed that extend radially on an other axial side than the chamber space, whose radially inner end communicates with the chamber space, and whose radially outer end communicates with a plurality of the magnet holes, and the radially outer end of each of the radial oil passages is in communication with a radially inner portion of each of the magnet holes.

As described above, during motor operation when the need for cooling is high, the rotor is constantly rotating and centrifugal force acts on the oil, so that the oil flowing axially inside the magnet hole also tends to collect in the radially outer part of the magnet hole. For this reason, if the radially outer end of the radial oil passage is connected to the radially outer part of the magnet hole where the oil collects, it is assumed that the oil will not be able to be smoothly introduced into the magnet hole.

In this regard, the radially outer end of the radial oil passage is connected to the radially inner portion of each magnet hole, in other words, connected to the portion of the magnet hole where an oil is less likely to collect, in this configuration, so that an oil can be smoothly introduced from the radial oil passage into the magnet hole, thereby making it possible to more efficiently cool the permanent magnet, which is the cooling target part.

Furthermore, in the rotor structure described above, it may be permissible that the one-side end plate is disposed so as to overlap, as viewed in a radial direction, a coil end on one axial side, which is one of the cooling target parts, of a stator coil attached to the stator, the one-side end plate has a plurality of first diffusion oil passages formed that extend radially on one axial side than the chamber space, whose radially inner end communicates with the chamber space, and that open on an outer peripheral surface of the one-side end plate, and each of the first diffusion oil passages is formed so that its cross-sectional area increases toward the radially outer side.

According to this configuration, a plurality of first diffusion oil passages are formed, which extend radially on one axial side than the chamber space (the opposite side of the rotor core across the chamber space), have radially inner ends communicating with the chamber space, and open on the outer circumferential surface of the one-side end plate, so that a portion of the oil filled in the chamber space can be scattered radially outward from the outer circumferential surface of the one-side end plate by centrifugal force through the plurality of first diffusion oil passages. Thus, the one-side end plate in which the first diffusion oil passages are formed is arranged so as to overlap the coil end on one axial side when viewed in the radial direction, so that the coil end on one axial side, which is one of the cooling target parts, can be cooled.

In addition, the oil that is scattered to the coil end, like the oil distributed to the magnet hole, is simply filled into the chamber space once, and is supplied to the coil ends in a sufficiently cooled state, rather than after cooling the rotor core, etc. (raising the temperature), so that not only the permanent magnet but also the coil end can be cooled efficiently.

Here, if the first diffusion oil passage is clogged with an oil, negative pressure would be generated within the first diffusion oil passage, which would impair the uniformity of the oil within the chamber space and hinder the even distribution of the oil to the plurality of magnet holes. In this regard, the first diffusion oil passage is formed so that the cross-sectional area increases as it goes radially outward, in this configuration, hence, it is possible to prevent the first diffusion oil passage from becoming clogged with an oil, and thereby making it possible to maintain efficient cooling of the permanent magnets while cooling the coil end.

Furthermore, in the rotor structure described above, it may be permissible that the rotor further comprises an annular other-side end plate attached concentric with the axis center of the rotor core to the end on an other axial side of the rotor core, the other-side end plate is disposed so as to overlap, as viewed in a radial direction, the coil end on the other axial side, which is one of the cooling target parts, of the stator coil, the other-side end plate has a plurality of second diffusion oil passages formed that extend radially, whose radially inner end communicates with a plurality of the magnet holes, that open on the outer peripheral surface of the other end plate, and whose cross-sectional area increases toward the radially outer side, and a number of the second diffusion oil passages is set to be greater than a number of the first diffusion oil passages.

According to this configuration, as in the case of the first diffusion oil passage described above, it is possible to cool the coil end on the other axial side, which is one of the cooling target parts. Also, like the first diffusion oil passage, the second diffusion oil passage is formed so that the cross-sectional area increases as it goes radially outward, so that it is possible to prevent the second diffusion oil passage from being blocked by an oil, and thus it is possible to prevent the occurrence of a phenomenon in which even distribution of an oil is impaired by an increase in the amount of an oil flowing through the magnet hole communicating with the second diffusion oil passage where negative pressure is generated.

Unlike the coil ends on one axial side, the coil end on the other axial side is supplied with an oil after cooling the rotor core, etc. (temperature-raised to a certain extent), but since the number of the second diffusion oil passages is set to be greater than the number of the first diffusion oil passages (so that the amount of an oil supplied to the coil end on the other axial side is relatively greater), hence, the coil end on the other axial side can also be cooled efficiently.

In the rotor structure described above, the rotor core may have a skew angle of 0 degrees.

According to this configuration, by making the rotor core so-called skewless, the flow passage resistance to the oil flowing inside the magnet hole can be reduced, thereby making it possible to more efficiently cool the permanent magnets, which are the cooling target parts.

### Advantageous Effect of the Invention

As described above, the rotor structure according to the present invention can efficiently cool the cooling target parts inside a synchronous motor.

### BRIEF DESCRIPTION OF THE DRAWINGS

FIG. 1 is a vertical sectional view schematically showing the outline of a synchronous motor according to an embodiment of the present invention.

FIG. 2 is a block diagram schematically illustrating an example of a cooling system in an electric vehicle.

FIG. 3 is a perspective view schematically showing a space in a rotor through which an oil flows.

FIG. 4 is a perspective view schematically illustrating the direction of an oil flowing in a rotor.

FIG. 5A is a perspective view schematically showing an oil introduction section.

FIG. 5B is a view showing the surface of the oil introduction section on the output axis side.

FIG. 5C is a sectional arrow view taken along the line c-c in FIG. 5A.

FIG. 6A is a perspective view schematically showing a main part of a shaft main body.

FIG. 6B is a sectional arrow view taken along the line b-b in FIG. 6A.

FIG. 6C is a sectional arrow view taken along the line c-c in FIG. 6A.

FIG. 7A is a perspective view schematically showing a main part of the shaft main body of a rotor shaft.

FIG. 7B is a sectional arrow view taken along the line b-b in FIG. 7A.

FIG. 7C is a sectional arrow view taken along the line c-c in FIG. 7A.

FIG. 7D is a perspective view showing the flow of an oil in the rotor shaft.

FIG. 8A is an overall cross-sectional view schematically showing a rotor core and a permanent magnet.

FIG. 8B is an enlarged view of the magnetic pole divided by the dashed lines in FIG. 8A.

FIG. 9A is a view schematically showing the surface of a second end plate on the anti-output axis side.

FIG. 9B is a sectional arrow view taken along the line b-b in FIG. 9A and FIG. 9C.

FIG. 9C is a view schematically showing the surface of the second end plate on the output axis side.

FIG. 9D is a perspective view schematically showing a first diffusion groove.

FIG. 9E is a perspective view schematically showing an annular groove and a connecting groove.

FIG. 10A is a view schematically showing the surface of a third end plate on the anti-output axis side.

FIG. 10B is a sectional arrow view taken along the line b-b in FIG. 10A and FIG. 10C.

FIG. 10C is a view schematically showing the surface of the third end plate on the output axis side.

FIG. 10D is a perspective view schematically showing an annular groove and a connecting groove.

FIG. 10E is a perspective view schematically showing a first radial groove and a second radial groove.

FIG. 11A is a cross-sectional view schematically showing a state where the second and the third end plate are stacked.

FIG. 11B is a perspective view schematically showing a space formed by stacking the second and third end plates.

FIG. 11C is a cross-sectional view schematically showing a state where the rotor shaft and the second and third end plates are combined.

FIG. 11D is a perspective view schematically showing a state where the rotor shaft and the second and third end plates are combined.

FIG. 11E is a perspective view schematically showing the flow of an oil in the rotor shaft and the second and third end plates.

FIG. 12A is a cross-sectional view schematically showing a state in which the first end plate and the second end plate are stacked.

FIG. 12B is a perspective view schematically showing a space formed by stacking the first and second end plates.

FIG. 12C is a perspective view schematically showing the flow of an oil in the rotor shaft and the first to third end plates.

FIG. 13A is a partial perspective view schematically showing a state in which a third end plate is attached to the end surface on the anti-output axis side of a rotor core.

FIG. 13B is a sectional arrow view taken along the line b-b in FIG. 13A.

FIG. 13C is a sectional arrow view taken along the line c-c in FIG. 13A.

FIG. 13D is a perspective view schematically showing the flow of an oil in the first to third end plates and in the rotor core.

FIG. 14A is a cross-sectional view schematically showing a main portion of a rotor core.

FIG. 14B is a cross-sectional view schematically showing a state where centrifugal force acts on the oil shown in FIG. 14A.

FIG. 15A is a perspective view schematically showing a radial oil passage.

FIG. 15B is a perspective view schematically showing a radial oil passage.

FIG. 16A is a view schematically showing the surface of a fourth end plate on the anti-output axis side.

FIG. 16B is a sectional arrow view taken along the line b-b in FIG. 16A and FIG. 16C.

FIG. 16C is a view schematically showing the surface of the fourth end plate on the output axis side.

FIG. 17A is a view schematically showing the surface of a fifth end plate on the anti-output axis side.

FIG. 17B is a perspective view schematically showing second diffusion grooves.

FIG. 18A is a partial perspective view schematically showing a state in which the fourth end plate and the fifth end plate are overlapped.

FIG. 18B is a perspective view schematically showing a space formed by overlapping the fourth and fifth end plates.

FIG. 18C is a cross-sectional view schematically showing a state in which the fourth and fifth end plates are attached to the rotor core, which correspond to the sectional arrow view taken along the line c-c in FIG. 18A.

FIG. 18D is a cross-sectional view schematically showing a state in which the fourth and fifth end plates are attached to the rotor core, which correspond to the sectional arrow view taken along the line d-d in FIG. 18A.

FIG. 18E is a perspective view schematically showing the flow of an oil in the rotor core and the fourth and fifth end plates.

FIG. 19 is a perspective view schematically showing outer and inner through holes.

FIG. 20A is a view schematically illustrating an example of an oil passage according to another embodiment.

FIG. 20B is a view schematically illustrating an example of an oil passage according to another embodiment.

FIG. 20C is a view schematically illustrating an example of an oil passage according to another embodiment.

FIG. 21 is a perspective view schematically showing a rotor core according to another embodiment of the present invention.

### DETAILED DESCRIPTION

Hereinafter, embodiments of the present invention will be described with reference to the drawings.

### -Motor Overview-

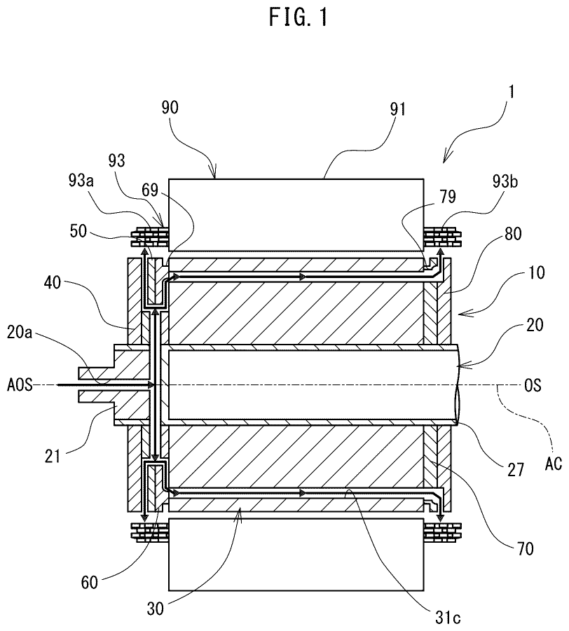

FIG. 1 is a vertical cross-sectional view schematically showing the overview of a synchronous motor 1 according to this embodiment. In FIG. 1, the symbol AC indicates the axis center of the synchronous motor 1, the symbol OS indicates an output axis side (the other axial side), and the symbol AOS indicates an anti-output axis side (one axial side), respectively. In FIG. 1, with respect to the stator 90, in order to make the drawing easier to see, a detailed cross section of a stator core 91 is not shown, and only the outer shape of the stator core 91 and coil ends 93a, 93b of a stator coil 93 attached to the stator core 91 are shown.

The synchronous motor 1 according to this embodiment is mounted, for example, on an electric vehicle, and as shown in FIG. 1, comprises a rotor 10 having a rotor core 30 with a rotor shaft 20 passing through the center, and a stator 90 having a stator core 91 arranged to surround the outer periphery of the rotor core 30, and is configured so that the rotor 10 rotates in synchronization with the rotating magnetic field generated by the stator 90.

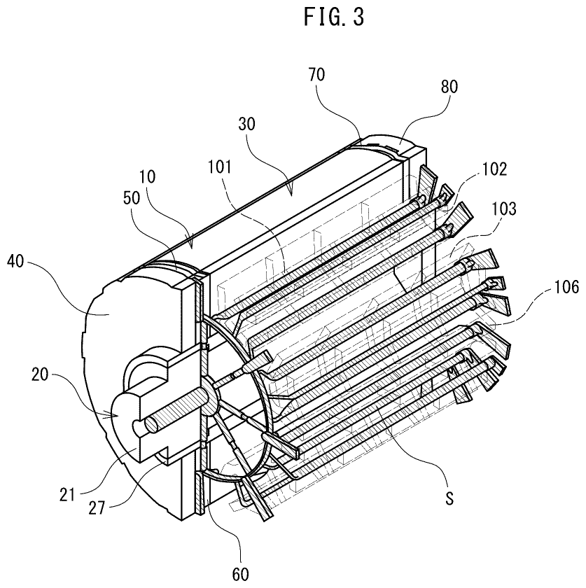

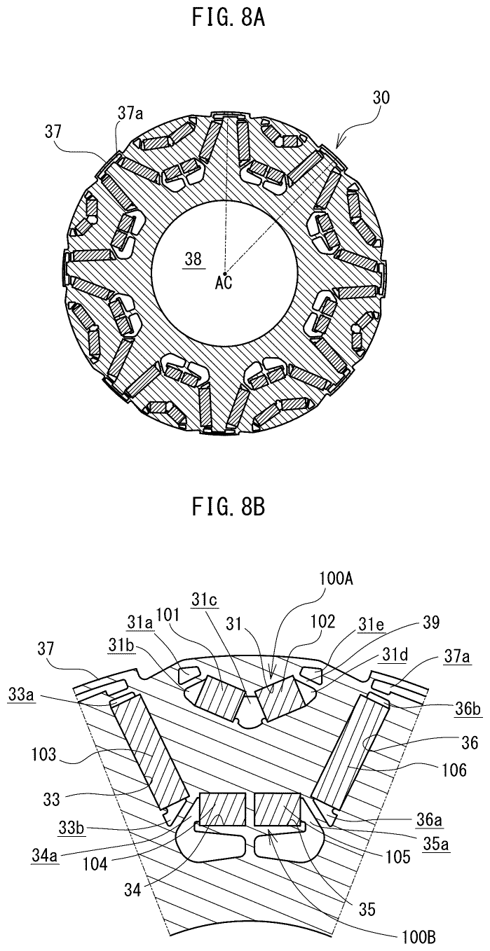

The rotor shaft 20 has an oil introduction section 21 and a shaft main body 27, and an oil introduction passage 20a through which an oil flows is formed therein. In addition to the rotor shaft 20 and the rotor core 30, the rotor 10 has permanent magnets 101, 102, 103, 106 (see FIG. 3, etc.) embedded in magnet holes 31 (see FIG. 8A and FIG. 8B) formed in the rotor core 30, and first to fifth end plates 40, 50, 60, 70, 80 attached to the ends of the rotor core 30 in the axial direction (the direction in which the axis AC extends). Note that FIG. 1 merely shows an outline of the synchronous motor 1, and since emphasis is placed on ease of understanding, the circumferential positions of the components in the rotor 10 are not necessarily consistently aligned.

### -Cooling System-

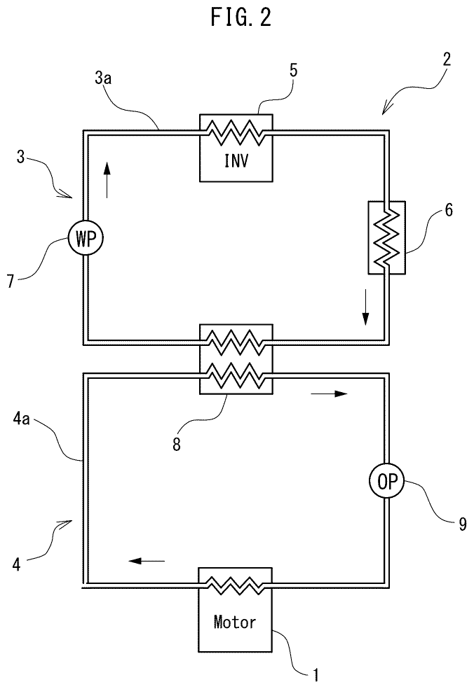

FIG. 2 is a block diagram schematically illustrating an example of a cooling system 2 in an electric vehicle. As shown in FIG. 2, the cooling system 2 includes an inverter cooling system 3 and a motor cooling system 4, and a heat exchanger 8 is interposed between the inverter cooling system 3 and the motor cooling system 4.

The inverter cooling system 3 has a circulation path 3a through which the cooling water circulates, and an inverter 5, a radiator 6, and a water pump 7 for circulating the cooling water, each of which is provided on the circulation path 3a. In the inverter cooling system 3, heat generated by the inverter 5 is absorbed by the cooling water, and the heat absorbed by the cooling water is dissipated to the outside by the radiator 6, thereby maintaining the cooling water and the inverter 5 at low temperatures.

On the other hand, the motor cooling system 4 has a circulation path 4a through which an oil circulates, and the motor 1 and an oil pump 9 that pumps an oil to an oil introduction section 21 of a rotor shaft 20, each of which is provided on the circulation path 4a. In this motor cooling system 4, heat generated in the synchronous motor 1 is absorbed by the oil, and the oil that has absorbed the heat accumulates at the bottom of a motor housing (not shown) and then returns to the circulation path 4a. In this motor cooling system 4, the heat absorbed by the oil is absorbed by the cooling water through indirect heat exchange between the circulation paths 3a and 4a in the heat exchanger 8, and then dissipated to the outside by the radiator 6, thereby maintaining the oil at a relatively low temperature.

In this embodiment, the cooling system 2 configured as described above allows an oil maintained at a relatively low temperature (for convenience, also referred to as “fresh oil”) to be sent to the oil introduction section 21 of the rotor shaft 20.

### -Outline of Rotor Structure-

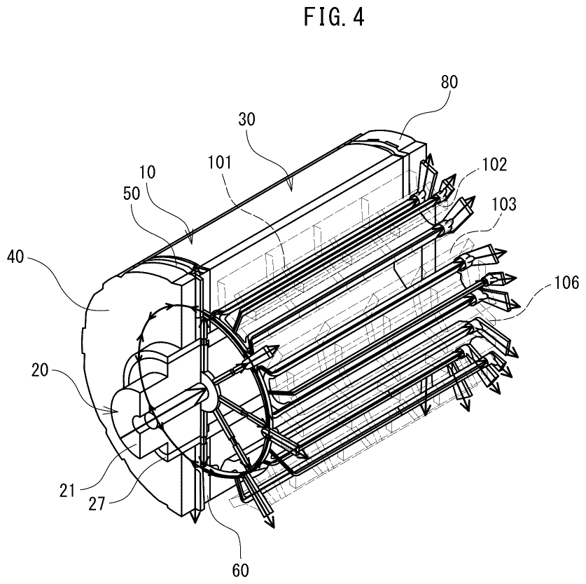

FIG. 3 is a perspective view schematically showing a space in the rotor 10 through which an oil flows, and FIG. 4 is a perspective view schematically illustrating a direction in which an oil flows in the rotor 10. In the rotor structure employed in this embodiment, a fresh oil sent to the oil introduction section 21 of the rotor shaft 20 as described above is appropriately distributed in the second and third end plates 50, 60 and is supplied directly to the gaps 31a in the magnet holes 31 in which the permanent magnets 101, 102, - - - , which are one of the cooling target parts inside the synchronous motor 1, are embedded, as shown by the thick arrow in FIG. 1, so that the permanent magnets 101, 102, - - - are efficiently cooled.

Similarly, a fresh oil is supplied directly also to the coil end 93a on the axially anti-output axis side AOS (hereinafter simply referred to as the “anti-output axis side AOS”), which is one of the cooling target parts, so that the coil end 93a is efficiently cooled. Furthermore, in this rotor structure, the coil end 93b on the axially output axis side OS (hereinafter simply referred to as the “output axis side OS”), which is one of the cooling target parts, is also efficiently cooled by the oil although after cooling the permanent magnets 101, 102, - - - .

More specifically, in the rotor structure of this embodiment, a space S through which an oil flows is formed inside the rotor shaft 20, the rotor core 30, and the first to fifth end plates 40, 50, - - - , as shown by hatching in FIG. 3. As a result, in this rotor structure, as shown by the thick arrows in FIG. 4, an oil flows circumferentially, radially, and axially, in other words, three-dimensionally, inside the rotor shaft 20, the rotor core 30, and the first to fifth end plates 40, 50, - - - , and is supplied to the cooling target part.

The rotor structure that enables such a three-dimensional oil flow will be described in detail below.

### -Details of Rotor Structure-

### <Rotor Shaft>

The rotor shaft 20 is inserted into a central hole 38 (see FIG. 8A and FIG. 8B) of the cylindrical rotor core 30 so as to be non-rotatable relative to this rotor core 30, and is rotatably supported by the motor housing, thereby enabling the rotor core 30 to rotate relative to the motor housing and also serving to introduce a fresh oil from the anti-output axis side AOS of the rotor 10 through the oil introduction passage 20a. As described above, the rotor shaft 20 has the oil introduction section 21 and the shaft main body 27.

### <Oil Introduction Section>

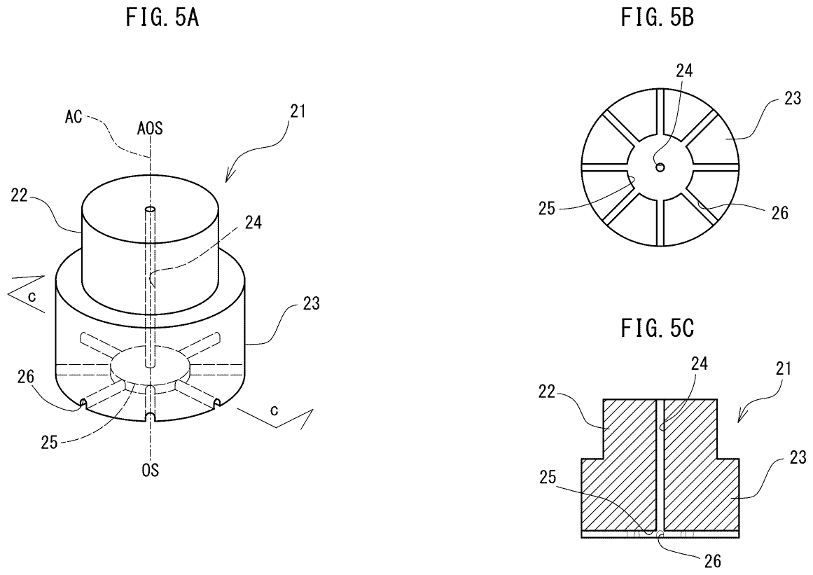

FIG. 5A is a perspective view schematically showing the oil introduction section 21. FIG. 5B is a view showing the surface of the oil introduction section 21 on the output axis side OS. FIG. 5C is a sectional arrow view taken along the line c-c in FIG. 5A. As shown in FIG. 5A, the oil introduction section 21 is formed in such a shape that a cylindrical small diameter portion 22 and a cylindrical large diameter portion 23 having an outer diameter larger than that of the small diameter portion 22 are connected in the axial direction via a step surface so as to be concentric about the axis center AC.

The oil introduction section 21 has an oil introduction hole 24 formed that passes through the small diameter portion 22 and the large diameter portion 23 in the axial direction through their axial centers. In addition, a recess 25 having a circular cross section that is recessed into the anti-output axis side AOS is formed at the end on the output axis side OS of the large diameter portion 23, as shown in FIG. 5A, FIG. 5B and FIG. 5C. The recess 25 communicates with the oil introduction hole 24 at its center. In addition, eight oil discharge grooves 26 that are recessed into the anti-output axis side AOS, radially extending from the recess 25 radially outward at equal intervals of 45 degrees in the circumferential direction, are formed at the end on the output axis side OS of the large diameter portion 23, as shown in FIG. 5A and FIG. 5B. The radially inner end, of each oil discharge groove 26, communicates with the recess 25, and the radially outer end thereof opens on the outer circumferential surface of the large diameter portion 23.

### <Shaft Main Body>

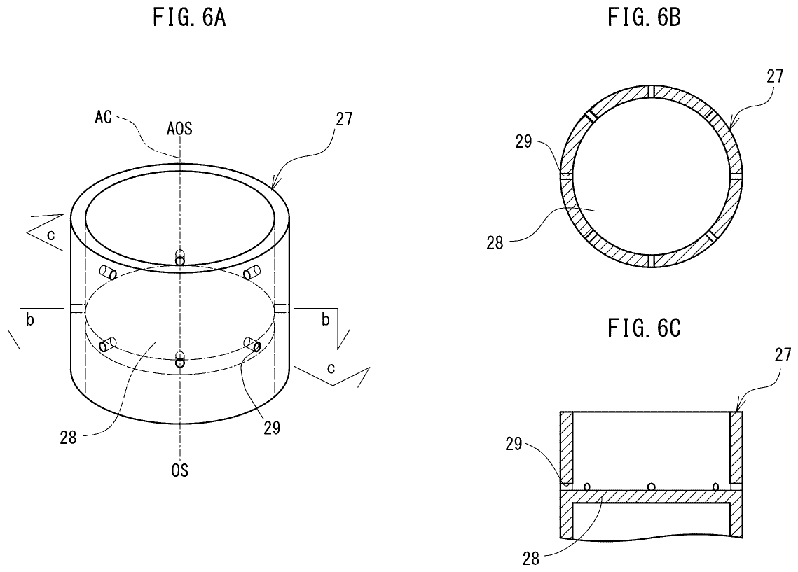

FIG. 6A is a perspective view schematically showing a main part of the shaft main body 27. FIG. 6B is a sectional arrow view taken along the line b-b in FIG. 6A. FIG. 6C is a sectional arrow view taken along the line c-c in FIG. 6A. As shown in FIG. 6A, the shaft main body 27 is formed in a cylindrical shape centered on the axis center AC, and the inner diameter thereof is set to be slightly larger than the outer diameter of the large diameter portion 23.

As shown in FIG. 6A and FIG. 6C, the shaft main body 27 is provided with a disk-shaped partition plate 28 that divides the hollow portion in the axial direction. The length from the end on the anti-output axis side AOS of the shaft main body 27 to the anti-output axis side AOS surface of the partition plate 28 is set to the same length as the axial length of the large diameter portion 23. Also, as shown in FIG. 6A and FIG. 6B, the shaft main body 27 has eight oil discharge holes 29 formed that extend radially outward at equal intervals of 45 degrees in the circumferential direction and penetrate the shaft main body 27. The oil discharge holes 29 are circular holes with a diameter substantially equal to the depth of the oil discharge groove 26, and are formed at positions that contact the anti-output axis side AOS surface of the partition plate 28.

### <Oil Introduction Passage>

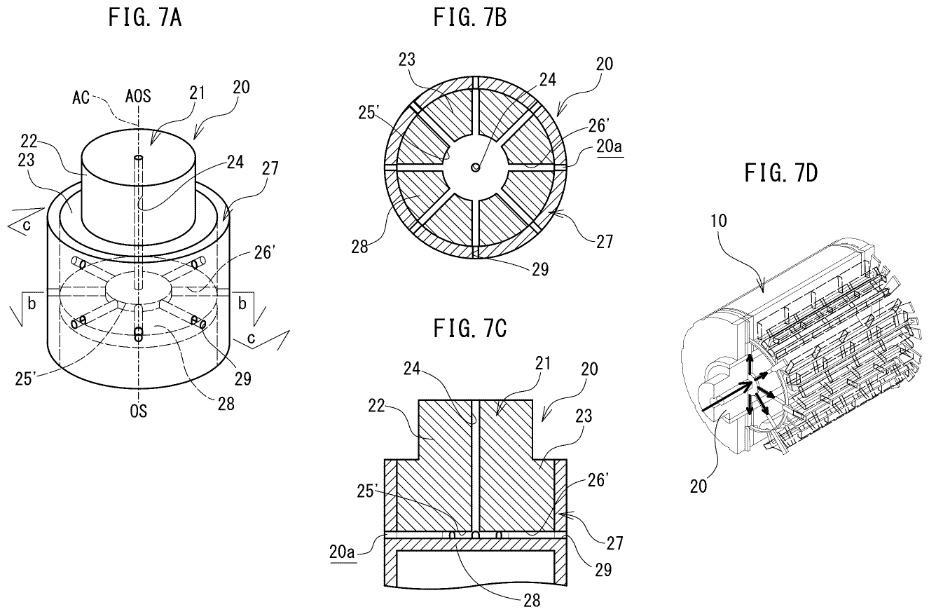

FIG. 7A is a perspective view schematically showing a main part of the shaft main body 27 of the rotor shaft 20. FIG. 7B is a sectional arrow view taken along the line b-b in FIG. 7A. FIG. 7C is a sectional arrow view taken along the line c-c in FIG. 7A. FIG. 7D is a perspective view showing the flow of an oil in the rotor shaft 20. The rotor shaft 20 is a combination of the oil introduction section 21 and the shaft main body 27 configured as described above. Specifically, the rotor shaft 20 is configured by fitting the large diameter portion 23 into the hollow part of the shaft main body 27 so that the circumferential positions of the eight oil discharge grooves 26 and the eight oil discharge holes 29 coincide with each other, and then joining the two by welding or the like.

When the oil introduction section 21 and the shaft main body 27 are combined, the recess 25 and the oil discharge groove 26 are covered by the surface of the partition plate 28 on the anti-output axis side AOS, thereby forming a disk-shaped space 25′ and an oil discharge passage 26′ having a closed cross section. As a result, the oil introduction passage 20a is formed, in which a fresh oil flows through the oil introduction hole 24 to the output axis side OS, fills the disk-shaped space 25′, flows from the disk-shaped space 25′ through the oil discharge passage 26′ radially outward, and is then sent out radially to the outside of the rotor shaft 20 through the oil discharge hole 29.

In this manner, the oil flow as shown in FIG. 7D, in other words, the portion of the oil flow in the rotor 10 shown in FIG. 4 that corresponds to the rotor shaft 20, is realized.

### <Rotor Core>

FIG. 8A is an overall cross-sectional view schematically showing the rotor core 30 and the permanent magnets 101, 102, - - - . FIG. 8B is an enlarged view of the magnetic pole divided by the dashed lines in FIG. 8A. The rotor core 30 is a laminated body in which a predetermined number of annular magnetic thin plates formed into a predetermined shape are stacked in the axial direction, and as shown in FIG. 8A, it is formed into a cylindrical shape having a central hole 38 to which the rotor shaft 20 is fixed by shrink fitting. As the material of the magnetic thin plates, electromagnetic steel plates, which are a type of silicon steel plates, can be used.

In the rotor core 30, a plurality of magnet holes 31, 33, 34, 35, 36 extending in the axial direction are formed so that the number of magnetic poles of the rotor 10 is eight and the prospect angle φ along the circumferential direction of one magnetic pole as seen from the axis AC is 45 degrees, and permanent magnets 101, 102, 103, 104, 105, 106 are embedded in the plurality of magnet holes 31, 33, - - - . The rotor core 30 is configured so that the skew angle is 0 degrees, and therefore the magnet holes 31, 33, - - - and the permanent magnets 101, 102, - - - extend straight in the axial direction from the end on the anti-output axis side AOS to the end on the output axis side OS of the rotor core 30. Although the positions and shapes of the magnet holes 31, 33, - - - and the permanent magnets 101, 102, - - - of each magnetic pole are different, the basic configuration is the same, so the magnet holes 31, 33, - - - and permanent magnets 101, 102, - - - of each magnetic pole will be explained by referring to the magnetic pole shown in the enlarged view of FIG. 8B as a representative of the eight magnetic poles.

As shown in FIG. 8B, each magnetic pole is configured with a two-layer structure of an outer embedded magnet section 100A including two permanent magnets 101, 102 arranged in a V-shape on the radially outer side, and an inner embedded magnet section 100B including four permanent magnets 103, 104, 105, 106 arranged in a U-shape on the radially inner side. Note that the protrusions 37 and the gaps 37a in the protrusions 37 shown in FIG. 8A and FIG. 8B are intended to suppress the generation of harmonic components contained in the magnetic flux, and are not related to this embodiment, so detailed description will be omitted.

The outer embedded magnet section 100A has one magnet hole 31, and the two permanent magnets 101, 102 are inserted into the magnet hole 31 so as to form a V-shape in which the distance between them increases radially outward and decreases radially inward. The portions of the magnet hole 31 that are not filled with the two permanent magnets 101, 102 and the portions defined by the bridge 39 remain as gaps (flux barriers) 31a, 31b, 31c, 31d, and 31e. Ofthese gaps 31a, 31b, 31c, 31d, and 31e, the gap 31c serves as an oil passage through which an oil flows to cool the permanent magnets 101, 102, as described below.

The inner embedded magnet section 100B has four magnet holes 33, 34, 35, and 36. The permanent magnets 103 and 106 are inserted into the magnet holes 33 and 36, respectively, so that the distance between them increases toward the radially outward direction and decreases toward the radially inward direction. The portions of the magnet holes 33 and 36 that are not filled with the permanent magnets 103 and 106 remain as gaps 33a, 33b, 36a, and 36b. The permanent magnets 104 and 105 are inserted into the magnet holes 34 and 35, respectively, and the portions of the magnet holes 34 and 35 that are not filled with the permanent magnets 104 and 105 remain as gaps 34a and 35a. Of these gaps 33a, 33b, 34a, 35a, 36a, and 36b, the gaps 33b and 36a serve as oil paths through which an oil flows for cooling the permanent magnets 103 and 106, as will be described later.

### <End Plate on Anti-Output Axis Side>

As shown in FIG. 1, FIG. 3 and FIG. 4, the end plates attached to the end on the anti-output axis side AOS of the rotor core 30 include first to third end plates 40, 50, 60. Note that, in relation to the claims, the first to third end plates 40, 50, 60 of this embodiment correspond to what is referred to in the present invention as “annular one-side end plate attached concentrically with the axis center of the rotor core to the end on one axial side of the rotor core.”

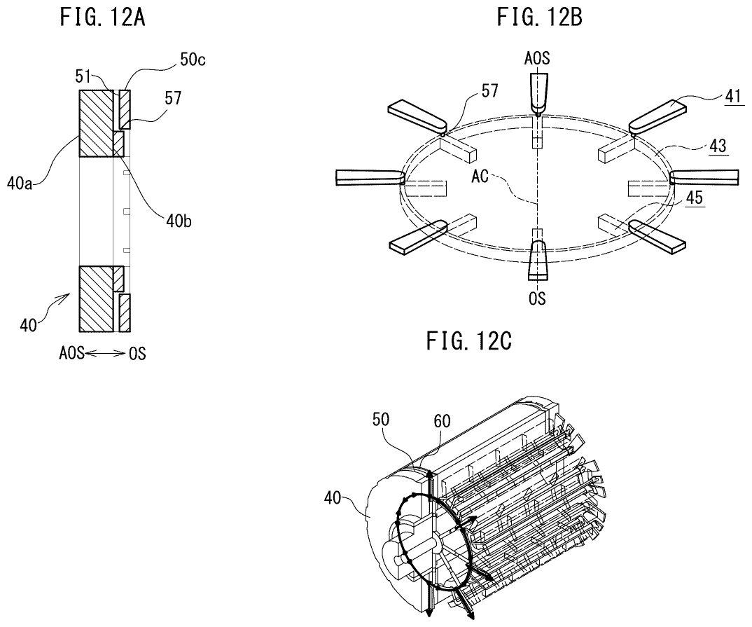

The first to third end plates 40, 50, 60 are annular aluminum plates having the same outer shapes as the outer and inner circumferential surfaces of the rotor core 30, and are assembled by welding or the like to form the end plates on the anti-output axis side AOS. As shown in FIG. 1, the first to third end plates 40, 50, 60 are arranged so as to overlap the coil end 93a on the anti-output axis side AOS, which is one of the cooling target parts, when viewed in the radial direction. As shown in FIG. 12A below, the first end plate 40 has a flat surface 40a (surface on the anti-output axis side AOS) and a flat back surface 40b (surface on the output axis side OS), and does not have any special features, so a detailed description thereof will be omitted.

### <Second End Plate>

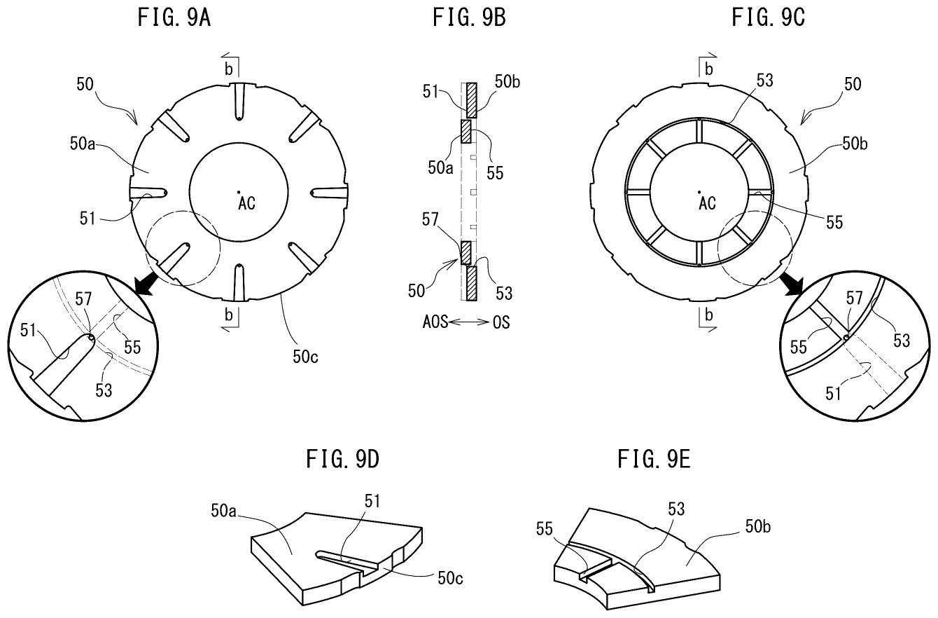

FIG. 9A is a view schematically showing the surface (surface 50a) of the second end plate 50 on the anti-output axis side AOS. FIG. 9B is a sectional arrow view taken along the line b-b in FIG. 9A and FIG. 9C. FIG. 9C is a view showing the surface (back surface 50b) on the output axis side OS. FIG. 9D is a perspective view showing the first diffusion groove 51. FIG. 9E is a perspective view showing the annular groove 53 and the connecting groove 55. The figures shown in the bold frames in FIG. 9A and FIG. 9C are partial enlarged views of the dashed frame. In FIG. 9B, the thickness of the second end plate 50 is exaggerated in comparison with the diameter in order to make the figure easier to see.

As shown in FIG. 9A and FIG. 9D, eight first diffusion grooves 51, extending radially outward at equal intervals of 45 degrees in the circumferential direction and recessed into the output axis side OS, are formed on the surface 50a of the second end plate 50. Each first diffusion groove 51 extends to the outer circumferential surface 50c of the second end plate 50 and opens at the outer circumferential surface 50c, and is formed so that the groove width increases radially outward.

On the other hand, as shown in FIG. 9C and FIG. 9E, an annular groove 53 having a circular ring shape, which is recessed toward the anti-output axis side AOS and is concentric with the axis center AC of the second end plate 50, is formed on the back surface 50b of the second end plate 50. In addition, eight connecting grooves 55, which extend radially outward from the inner circumferential surface of the second end plate 50 at equal intervals of 45 degrees in the circumferential direction and connect to the annular groove 53, and which are recessed into the anti-output axis side AOS, are formed on the back surface 50b of the second end plate 50.

As shown in the bold frames in FIG. 9A and FIG. 9C and in FIG. 9B, the radially inner end of the first diffusion groove 51 formed on the surface 50a overlaps with the annular groove 53 formed on the back surface 50b when viewed in the axial direction. The eight first diffusion grooves 51 formed on the surface 50a and the eight connecting grooves 55 formed on the back surface 50b are aligned in the circumferential direction and extend radially on the same radius. The first diffusion grooves 51 formed on the surface 50a and the annular groove 53 formed on the back surface 50b communicate with each other through a communication hole 57 that has a circular cross section and extends in the axial direction at the overlapping portion.

### <Third End Plate>

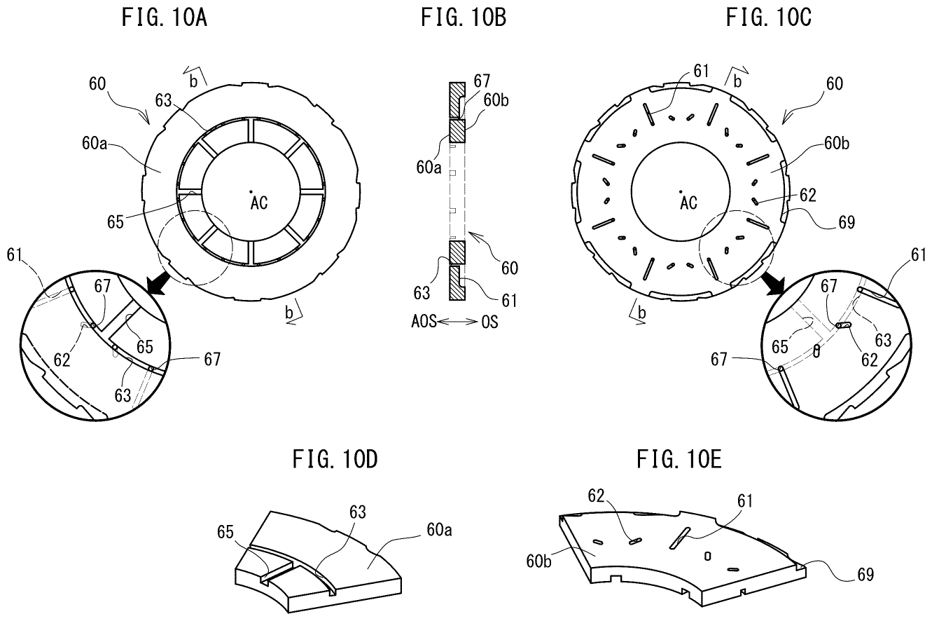

FIG. 10A is a view schematically showing the surface (surface 60a) of the third end plate 60 on the anti-output axis side AOS. FIG. OB is a sectional arrow view taken along the line b-b in FIG. 10A and FIG. 10C. FIG. 1C is a view schematically showing the surface (back surface 60b) of the third end plate 60 on the output axis side OS. FIG. 10D is a perspective view schematically showing the annular groove 63 and the connecting groove 65. FIG. 10E is a perspective view schematically showing the first and second radial grooves 61, 62. The figures shown in the bold frames in FIG. 10A and FIG. 10C are partial enlarged views of the dashed frame. In FIG. 10B, the thickness of the third end plate 60 is exaggerated in comparison with the diameter in order to make the figure easier to see.

As shown in FIG. 1C and FIG. 10E, a circular annular groove 63 recessed toward the output axis side OS, concentric with the axis center AC of the third end plate 60, is formed on the surface 60a of the third end plate 60. In addition, eight connecting grooves 65 recessed toward the output axis side OS, extending radially outward from the inner circumferential surface of the third end plate 60 at equal intervals of 45 degrees in the circumferential direction and connecting to the annular groove 63, are formed on the surface 60a of the third end plate 60.

On the other hand, as shown in FIG. 1C and FIG. 10E, eight first radial grooves 61 recessed into the anti-output axis side AOS, which extend radially outward at equal intervals of 45 degrees in the circumferential direction, are formed on the back surface 60b of the third end plate 60. Also, sixteen rows of second radial grooves 62, two of which are provided between circumferentially adjacent first radial grooves 61, which extend at an inclination in the circumferential direction as they move radially outward, and which are recessed into the anti-output axis side AOS, are formed on the back surface 60b of the third end plate 60. The length of the second radial grooves 62 is set shorter than the length of the first radial grooves 61.

As shown in the bold frames in FIG. 10A and FIG. 10C and in FIG. 10B, the radially inner ends of the first and second radial grooves 61, 62 formed on the back surface 60b overlap with the annular groove 63 formed on the surface 60a when viewed in the axial direction. The first and second radial grooves 61, 62 formed on the back surface 60b communicate with the annular groove 63 formed on the surface 60a through a communication hole 67 having a circular cross section and extending in the axial direction at the overlapping portion.

However, unlike the relationship between the first diffusion groove 51 and the connecting groove 55 in the second end plate 50, the eight first radial grooves 61 and the sixteen rows of second radial grooves 62 formed on the back surface 60b do not coincide in circumferential position with the eight connecting grooves 65 formed on the surface 60a. In other words, the communication hole 67 that communicates the first and second radial grooves 61, 62 formed on the back surface 60b with the annular groove 63 formed on the surface 60a do not coincide in circumferential position with the connecting groove 65.

Furthermore, as shown in FIG. 10C and FIG. 10E, eight U-shaped discharge recesses 69 at equal intervals of 45 degrees in the circumferential direction, with the outer peripheral edge recessed toward the anti-output axis side AOS, are formed on the back surface 60b of the third end plate 60.

### <Chamber Space>

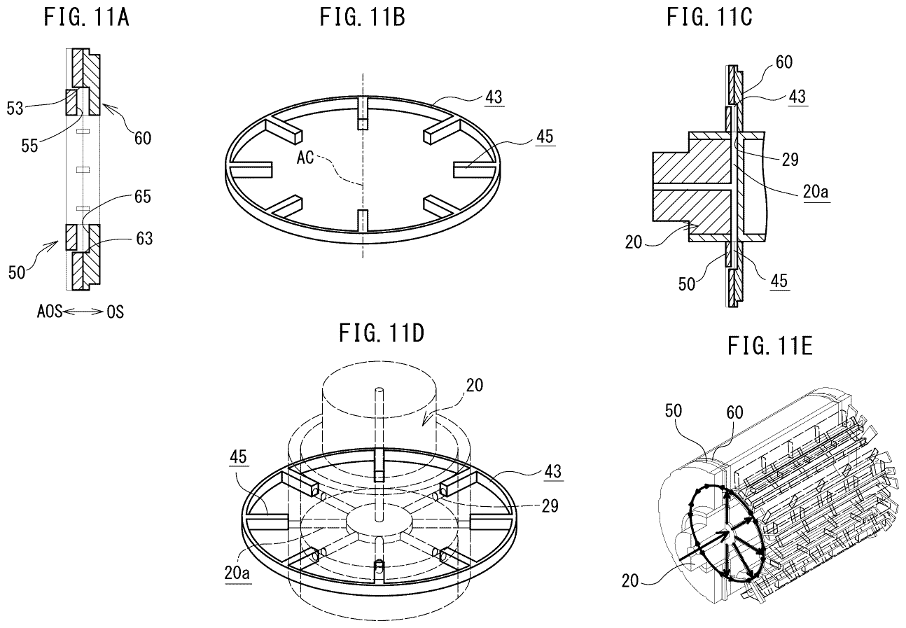

FIG. 11A is a cross-sectional view schematically showing a state where the second and the third end plates 50, 60 are stacked. FIG. 11B is a perspective view schematically showing a space formed by stacking the second and third end plates 50, 60. FIG. 11C and FIG. 11D are a cross-sectional view and a perspective view, respectively, schematically showing a state where the rotor shaft 20 and the second and third end plates 50, 60 are combined. FIG. 11E is a perspective view schematically showing the flow of an oil in the rotor shaft 20 and the second and third end plates 50, 60. In FIG. 11A, the thicknesses of the second and third end plates 50, 60 are exaggerated compared to the diameters in order to make the figure easier to see.

As shown in FIG. 11A, when the back surface 50b of the second end plate 50 and the surface 60a of the third end plate 60 are overlapped concentrically in the axial direction so that the connecting grooves 55 and 65 coincide in the circumferential direction, a chamber space 43 that is annular when viewed in the axial direction, defined by the annular grooves 53 and 63 is formed concentrically with the axis center AC as shown in FIG. 11B. In addition, eight connecting flow paths 45 are also formed that extend radially outward from the inner circumferential surfaces of the second and third end plates 50, 60, defined by the connecting grooves 55 and 65, at equal intervals of 45 degrees in the circumferential direction, and connect (communicate) with the chamber space 43.

As shown in FIG. 11C, when the rotor shaft 20 is combined with the second and third end plates 50, 60 so that the eight oil discharge holes 29 and the eight connecting passages 45 coincide in the circumferential direction, in other words, so that the eight oil discharge holes 29 and the eight connecting passages 45 communicate with each other, the oil introduction passage 20a of the rotor shaft 20 communicates with the chamber space 43 via the connecting passage 45, as shown in FIG. 11D. As a result, a fresh oil radially sent out from the oil introduction passage 20a of the rotor shaft 20 fills the chamber space 43.

In this manner, the oil flow as shown in FIG. 11E, in other words, the portion of the oil flow in the rotor 10 shown in FIG. 4 that corresponds to the rotor shaft 20 and the second and third end plates 50, 60, is realized.

### <First Diffusion Oil Passage>

FIG. 12A is a cross-sectional view schematically showing a state wherein the first and second end plates 40, 50 are stacked. FIG. 12B is a perspective view schematically showing a space formed by stacking the first and second end plates 40, 50. FIG. 12C is a perspective view schematically showing the flow of an oil in the rotor shaft 20 and the first to third end plates 40, 50, 60. FIG. 11A shows the thicknesses of the first and second end plates 40, 50 exaggerated in comparison with their diameters in order to make the drawing easier to see.

As shown in FIG. 12A, when the back surface 40b of the first end plate 40 and the surface 50a of the second end plate 50 are overlapped concentrically in the axial direction, the first diffusion groove 51 is covered by the back surface 40b of the first end plate 40, and eight first diffusion oil passages 41 are formed as spaces extending radially on the anti-output axis side AOS than the chamber space 43, as shown in FIG. 12B. Since each first diffusion oil passage 41 is formed by covering the first diffusion groove 51, the passage 41 is formed so that the radially inner end communicates with the chamber space 43 via a communication hole 57, opening is formed on the outer circumferential surface 50c of the second end plate 50, and the cross-sectional area increases as it goes radially outward, like the first diffusion groove 51.

By forming these eight first diffusion oil passages 41, it becomes possible for a portion of the fresh oil filled in the chamber space 43 to be scattered radially outward from the outer circumferential surface 50c of the second end plate 50 by centrifugal force through these first diffusion oil passages 41. In this way, the first to third end plates 40, 50, 60 are arranged so as to overlap radially with the coil end 93a on the anti-output axis side AOS, and therefore it is possible to cool the coil end 93a, which is one of the cooling target parts.

Furthermore, the oil that is scattered to the coil end 93a is simply filled once into the chamber space 43 formed in the second and third end plates 50, 60, which are separate from the rotor core 30, and is supplied to the coil end 93a while still in a sufficiently cooled state, rather than after cooling the rotor core 30, etc. (raising the temperature), so that the coil end 93a can be cooled efficiently.

Here, if the first diffusion oil passage 41 is blocked by an oil, a case is also assumed in which negative pressure would be generated within the first diffusion oil passage 41, which could result in loss of uniformity of the oil within the chamber space 43. However, in this embodiment, the first diffusion oil passage 41 is formed so that the cross-sectional area increases as it goes radially outward, making it possible to prevent the first diffusion oil passage 41 from being blocked by an oil, and thus making it possible to maintain uniformity of the oil within the chamber space 43 while cooling the coil end 93a.

In this manner, the oil flow as shown in FIG. 12C, in other words, the portion of the oil flow in the rotor 10 shown in FIG. 4 that corresponds to the first to third end plates 40, 50, 60, is realized.

### <Radial Oil Passage>

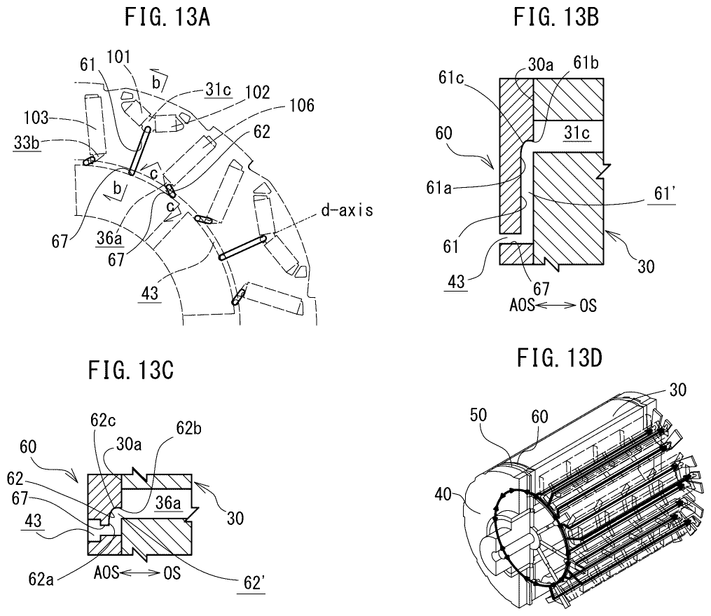

FIG. 13A is a partial perspective view schematically showing a state in which the third end plate 60 is attached to the end surface 30a on the anti-output axis side AOS of the rotor core 30. FIG. 13B and FIG. 13C are sectional arrow views taken along the lines b-b and c-c in FIG. 13A, respectively. FIG. 13D is a perspective view schematically showing the flow of an oil in the first to third end plates 40, 50, and 60 and in the rotor core 30. In FIG. 13A, dashed lines are used to show those other than the radial oil passages 61′ and 62′ in order to make the drawing easier to see. In FIG. 13B and FIG. 13C, the thickness of the third end plate 60 is exaggerated compared to the diameter in order to make the drawing easier to see.

As shown in FIG. 13A, when the back surface 60b of the third end plate 60 is attached to the end surface 30a on the anti-output axis side AOS of the rotor core 30 by welding or the like so that the first radial grooves 61 and the center lines (so-called d-axis) of the magnetic poles coincide in the circumferential direction, the first radial groove 61 is covered by the end surface 30a on the anti-output axis side AOS of the rotor core 30, and eight first radial oil passages 61′ extending radially on the output axis side OS than the chamber space 43 are formed, as shown in FIG. 13B. Since each of the first radial oil passages 61′ is obtained by covering the first radial groove 61, the radially inner end communicates with the chamber space 43 via the communication hole 67, similar to the first radial groove 61. The length of the first radial oil passage 61′ is set so that the radially outer end communicates with the gap 31c of the magnet hole 31.

The second radial groove 62 is also covered by the end surface 30a on the anti-output axis side AOS of the rotor core 30, and sixteen rows of second radial oil passages 62′ are formed, extending at an inclination in the circumferential direction toward the radially outer side on the output axis side OS than the chamber space 43. Since each second radial oil passage 62′ is obtained by covering the second radial groove 62, the radially inner end communicates with the chamber space 43 via a communication hole 67, similar to the second radial groove 62. The length and inclination direction of the second radial oil passage 62′ are set so that the radially outer end communicates with the gap 36a (or gap 33b) of the magnet hole 36.

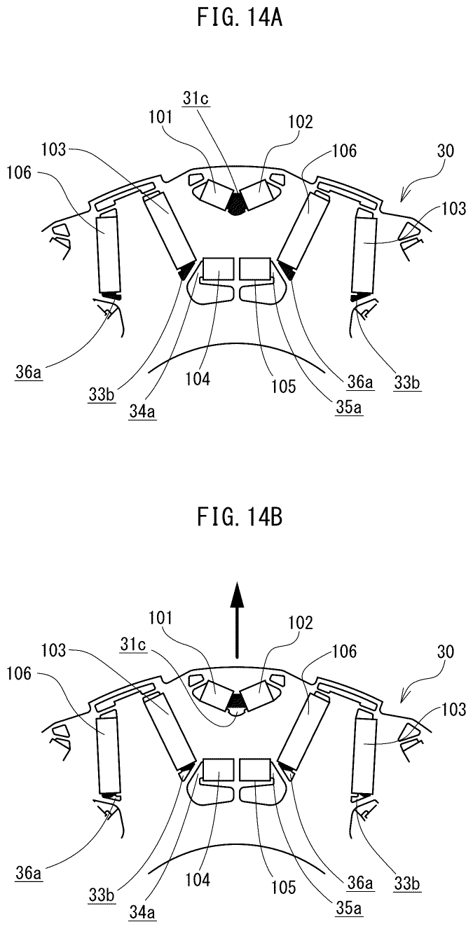

FIG. 14A is a cross-sectional view schematically showing a main part of the rotor core 30. In FIG. 14A, the oil is shown as a black portion. FIG. 14B is a cross-sectional view schematically showing a state where centrifugal force acts on the oil shown in FIG. 14A. In the rotor structure of this embodiment, by forming such eight first radial oil passages 61′ and sixteen rows of second radial oil passages 62′, the oil flows from the anti-output axis side AOS to the output axis side OS through 24 gaps 31c, 33b, 36a (in magnet holes 31, 33, 36) inside the rotor core 30, as shown by the black portion in FIG. 13A.

In this way, the oil flows axially inside the rotor core 30 through the plurality of gaps 31c, 33b, 36a, and the oil can directly cool the permanent magnets 101, 102, 103, 106, which are one of the cooling target parts. This allows the permanent magnets 101, 102, - - - to be cooled more efficiently than, for example, a structure in which an oil flows through holes (oil passages) provided near the permanent magnets 101, 102, - - - in the rotor core 30.

Furthermore, the rotor structure of this embodiment is configured such that an oil is filled into the chamber space 43 from the oil introduction passage 20a of the rotor shaft 20, and the oil is distributed from the chamber space 43 to the plurality of gaps 31c, 33b, and 36a, therefore, compared to a structure in which an oil is sent directly from the oil introduction passage 20a to the gaps 31c, 33b, and 36a, for example, the oil can be distributed evenly to the plurality of gaps 31c, 33b, and 36a.

As described above, the communication hole 67 that communicates the first and second radial grooves 61, 62 formed in the back surface 60b with the annular groove 63 formed in the surface 60a does not coincide in circumferential position with the connecting groove 65. Therefore, a fresh oil that is filled into the chamber space 43 through the eight connecting flow paths 45 tends to flow evenly to the eight first radial oil passages 61′ and the sixteen rows of second radial oil passages 62′, making it possible to distribute the oil more evenly to the plurality of gaps 31c, 33b, 36a.

In addition, the oil distributed to the gaps 31c, 33b, 36a is simply temporarily filled in the chamber space 43 formed in the second and third end plates 50, 60 that are separate from the rotor core 30, and is supplied to the gaps 31c, 33b, 36a in a sufficiently cooled state, rather than after cooling the rotor core 30, etc. (raising the temperature), so that the permanent magnets 101, 102, - - - can be effectively cooled. This makes it possible to prevent the permanent magnets 101, 102, - - - from being insufficiently cooled, and therefore makes it possible to prevent the permanent magnets 101, 102, - - - from being demagnetized, and thus to prevent a decrease in torque.

In addition, in the rotor structure of this embodiment, as described above, the rotor core 30 is so-called skewless, so that the flow passage resistance to the oil flowing through the gaps 31c, 33b, 36a can be reduced, thereby making it possible to cool the permanent magnets 101, 102, - - - even more efficiently.

In this embodiment, as shown in FIG. 14A, no oil is flowed into the gaps 34a, 35a (the permanent magnets 104, 105 are not targeted for cooling), and this is because, if too much oil is flowed from the chamber space 43 toward the rotor core 30, the amount of a fresh oil supplied to the coil end 93a will be reduced too much, and because the permanent magnets 101, 102, 103, and 106 closer to the stator 90 are more likely to reach high temperatures than the permanent magnets 104, 105 farther from the stator 90.

In contrast, during motor operation when the need for cooling is high, the rotor 10 is constantly rotating, and centrifugal force acts on the oil (see the thick arrow in FIG. 14B), so that the oil flowing axially through the gaps 31c, 33b, 36a (inside the magnet holes 31, 33, 36) also tends to collect in the radially outer portions of the gaps 31c, 33b, 36a, as shown in FIG. 14B. For this reason, if the radially outer ends of the first and second radial oil passages 61′, 62′ were connected to the radially outer portions of the gaps 31c, 33b, 36a where the oil collects, it is conceivable that the oil would not be smoothly introduced into the gaps 31c, 33b, 36a.

In addition, while the oil flows radially outward through the first and second radial oil passages 61′, 62′, it flows axially when supplied to the gaps 31c, 33b, 36a, then, if surfaces 61a, 62a defining the first and second radial oil passages 61′, 62′ on the anti-output axis side AOS (referred to as “first defining surface”) and surfaces 61b, 62b defining the first and second radial oil passages 61′, 62′ on the radially outer side (referred to as “second defining surface”) are perpendicular to each other, it is supposed that the oil will not change direction smoothly. In addition, as described above, centrifugal force also acts on the oil, so that the oil flowing radially through the first and second radial oil passages 61′, 62′ is likely to be pressed against the second defining surfaces 61b, 62b, therefore, in cases where the first defining surfaces 61a, 62a and the second defining surfaces 61b, 62b are perpendicular to each other, it is expected that the oil will have even more difficulty in changing direction.

Therefore, in the rotor structure of this embodiment, the radially outer ends of the first and second radial oil passages 61′, 62′ are connected to the radially inner portions of the gaps 31c, 33b, 36a, and the first defining surfaces 61a, 62a and the second defining surfaces 61b, 62b are connected in an R-shape when viewed in the circumferential direction.

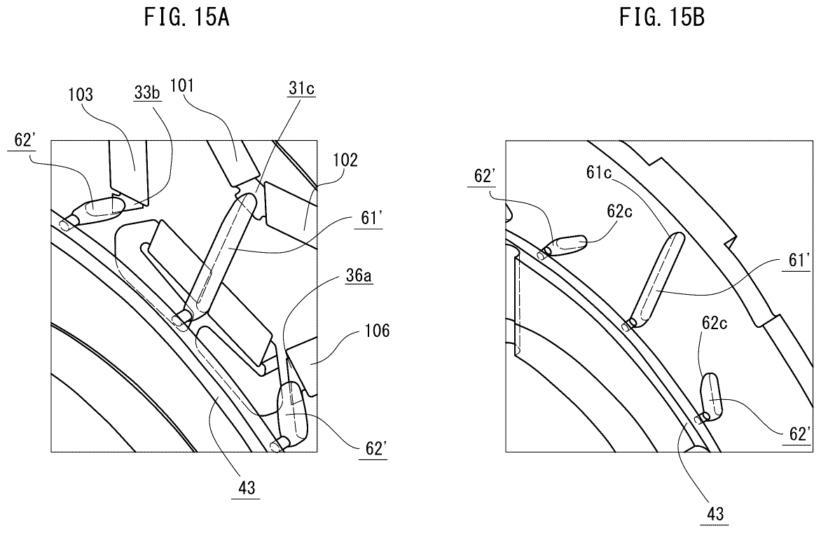

FIG. 15A and FIG. 15B are perspective views schematically showing the first and second radial oil passages 61′, 62′. In this embodiment, as shown in FIG. 13B and FIG. 13C and FIG. 15A, the radially outer ends of the first and second radial oil passages 61′, 62′ communicate with the radially inner portions of the gaps 31c, 33b, 36a, in other words, communicate with the parts of the gaps 31c, 33b, 36a where the oil does not collect, so that the oil can be smoothly introduced from the first and second radial oil passages 61′, 62′ to the gaps 31c, 33b, 36a.

As shown in FIG. 13B and FIG. 13C and FIG. 15B, the first defining surfaces 61a, 62a and the second defining surfaces 61b, 62b are connected by the R-shaped portions 61c, 62c when viewed in the circumferential direction, so that when the oil flowing radially outward through the first and second radial oil passages 61′, 62′ is supplied to the gaps 31c, 33b, 36a under centrifugal force, smooth direction change to the axial direction can be realized. As a result, the permanent magnets 101, 102, 103, 106, which are one of the cooling target parts, can be cooled more efficiently.

In this manner, the oil flow as shown in FIG. 13D, in other words, the portion of the oil flow in the rotor 10 shown in FIG. 4 that corresponds to the second and third end plates 50, 60 and the rotor core 30, is realized.

### <End Plate on Output Axis Side>

As shown in FIG. 1, FIG. 3 and FIG. 4, the end plates attached to the end on the output axis side OS of the rotor core 30 include fourth and fifth end plates 70, 80. In relation to the claims, the fourth and fifth end plates 70, 80 of this embodiment correspond to “annular other-side end plate attached concentrically with the axis center of the rotor core to the end on the other axial side of the rotor core” referred to in the present invention.

The fourth and fifth end plates 70, 80, like the first to third end plates 40, 50, 60, are annular aluminum plates that have the same outer shapes as the outer and inner peripheral surfaces of the rotor core 30 and are assembled by welding or the like to form the end plates on the output axis side OS. As shown in FIG. 1, the fourth and fifth end plates 70, 80 are arranged to overlap, when viewed in the radial direction, with the coil end 93b on the output axis side OS, which is one of the cooling target parts.

### <Fourth End Plate>

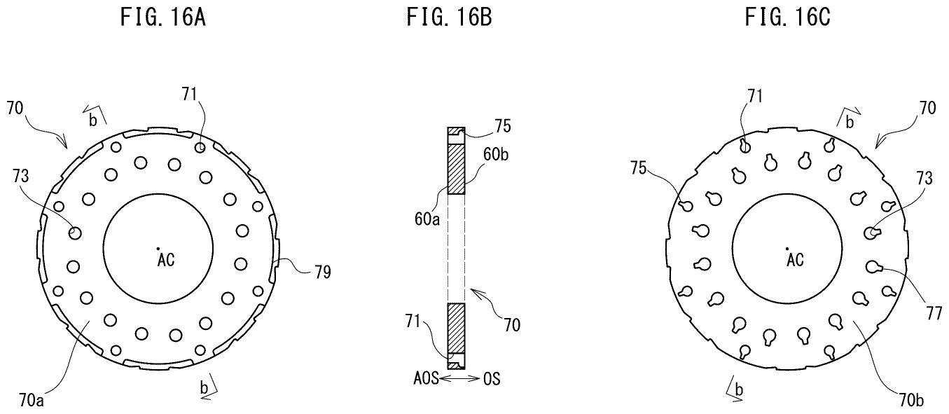

FIG. 16A is a view schematically showing the surface (surface 70a) of the fourth end plate 70 on the anti-output axis side AOS. FIG. 16B is a sectional arrow view taken along the line b-b in FIG. 16A and FIG. 16C. FIG. 16C is a view schematically showing the surface (back surface 70b) of the fourth end plate 70 on the output axis side OS. FIG. 16B shows the thickness of the fourth end plate 70 exaggerated in comparison with its diameter in order to make the drawing easier to see.

As shown in FIG. 16A, FIG. 16B and FIG. 16C, the fourth end plate 70 has eight outer through holes 71 formed that penetrate the fourth end plate 70 at equal intervals of 45 degrees in the circumferential direction. The radial positions of these outer through holes 71 correspond to the eight gaps 31c, respectively. In addition, the fourth end plate 70 has sixteen inner through holes 73 formed that penetrate the fourth end plate 70 radially inward of the outer through holes 71 and have a larger diameter than the outer through holes 71. The radial positions of these inner through holes 73 correspond to the sixteen gaps 33b, 36a, respectively.

As shown in FIG. 16A, eight U-shaped discharge recesses 79 with the outer circumferential edge recessed toward the output axis side OS are formed, at equal intervals of 45 degrees in the circumferential direction, on the surface 70a of the fourth end plate 70. Meanwhile, as shown in FIG. 16C, the back surface 70b of the fourth end plate 70 has trapezoidal communication grooves 75, 77 formed, as views in the axial direction, which protrude radially outward from the outer through hole 71 and the inner through hole 73 and are recessed toward the anti-output axis side AOS.

### <Fifth End Plate>

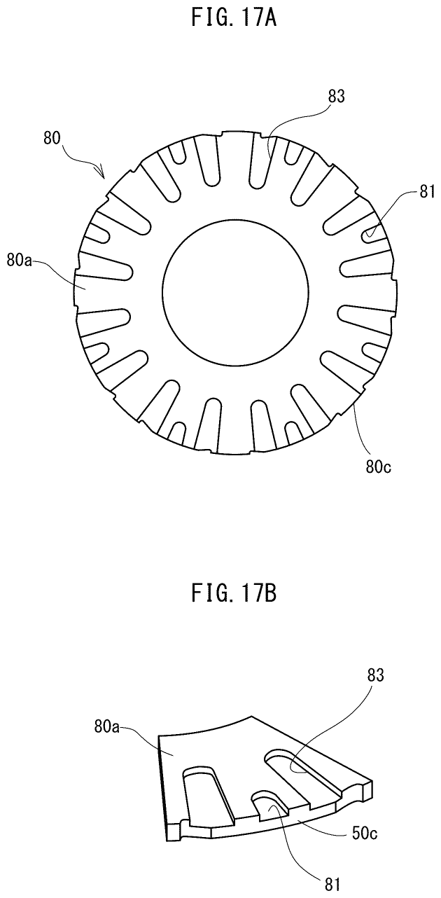

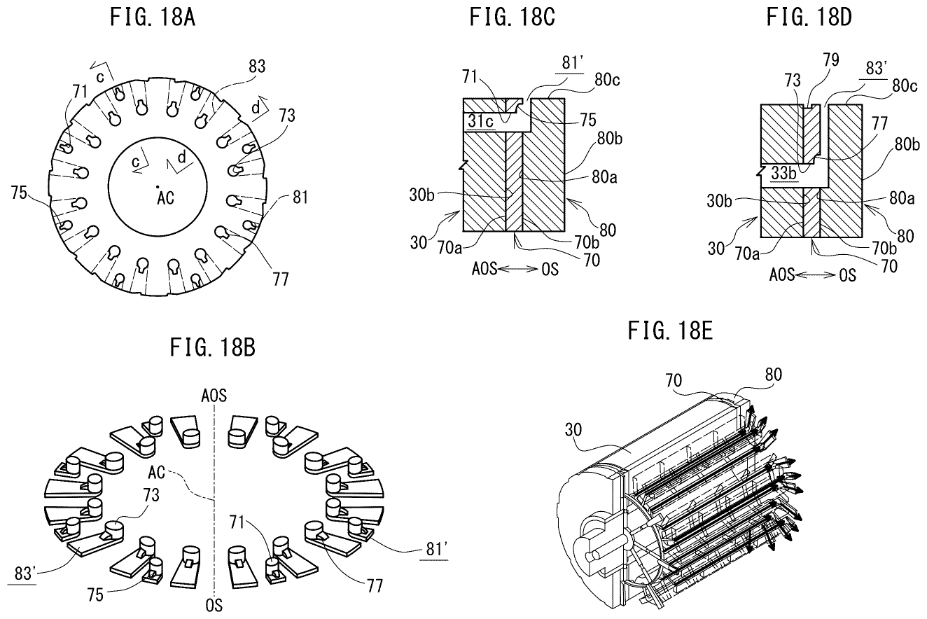

FIG. 17A is a view schematically showing the surface (surface 80a) of the fifth end plate 80 on the anti-output axis side AOS. FIG. 17B is a perspective view schematically showing the second diffusion grooves 81, 83. Note that the surface (back surface 80b (see FIG. 18A, FIG. 18B, FIG. 18C, FIG. 18D and FIG. 18E)) of the fifth end plate 80 on the output axis side OS is formed flat and has no distinctive features, so a detailed description thereof will be omitted.

As shown in FIG. 17A and FIG. 17B, eight second short diffusion grooves 81, extending radially outward at equal intervals of 45 degrees in the circumferential direction and recessed into the output axis side OS, are formed on the surface 80a of the fifth end plate 80. The second short diffusion grooves 81 have radially inner ends that substantially coincide with the outer through holes 71, and extend to the outer peripheral surface 80c of the fifth end plate 80 and open at the outer peripheral surface 80c. The second short diffusion grooves 81 are formed so that their groove width increases radially outward.

Further, sixteen second long diffusion grooves 83, that extend radially outward in the radial direction, are recessed toward the output axis side OS, and are longer than the second short diffusion grooves 81, are formed on the surface 80a of the fifth end plate 80. The radially inner ends of the second long diffusion grooves 83 are approximately aligned with the inner through holes 73, and extend to the outer circumferential surface 80c of the fifth end plate 80 and open at the outer circumferential surface 80c. Like the second short diffusion grooves 81, the second long diffusion grooves 83 are formed so that their groove width increases radially outward.

### <Second Diffusion Oil Passage>

FIG. 18A is a partial perspective view schematically showing a state where the fourth end plate 70 and the fifth end plate 80 are overlapped. FIG. 18B is a perspective view schematically showing a space formed by overlapping the fourth and fifth end plates 70, 80. FIG. 18C and FIG. 18D are cross-sectional views schematically showing a state in which the fourth and fifth end plates 70, 80 are attached to the rotor core 30, which correspond to the sectional arrow views taken along the lines c-c and d-d in FIG. 18A, respectively. FIG. 18E is a perspective view schematically showing the flow of an oil in the rotor core 30 and the fourth and fifth end plates 70, 80. In FIG. 18C and FIG. 18D, the thicknesses of the fourth and fifth end plates 70, 80 are exaggerated compared to the diameters in order to make the drawings easier to see.

As shown in FIG. 18A, when the back surface 70b of the fourth end plate 70 and the surface 80a of the fifth end plate 80 are concentrically stacked in the axial direction, the second short diffusion groove 81 is covered by the back surface 70b of the fourth end plate 70, and eight second short diffusion oil passages 81′, which are spaces extending in the radial direction, are formed as shown in FIG. 18B. Since each second short diffusion oil passage 81′ is obtained by covering the second short diffusion groove 81, like the second short diffusion groove 81, the radially inner end communicates with the outer through hole 71 and opens on the outer peripheral surface 80c of the fifth end plate 80, and is formed so that the cross-sectional area increases as it goes radially outward.

Similarly, the second long diffusion grooves 83 are covered by the back surface 70b of the fourth end plate 70, forming 16 second long diffusion oil passages 83′ which are spaces extending in the radial direction. Since each second long diffusion oil passage 83′ is obtained by covering the second long diffusion groove 83, like the second long diffusion groove 83, the radially inner end communicates with the inner through hole 73 and opens on the outer circumferential surface 80c of the fifth end plate 80, and is formed so that the cross-sectional area increases radially outward.

When the surface 70a of the fourth end plate 70 is attached to the end surface 30b on the output axis side OS of the rotor core 30 by welding or the like so that the outer through hole 71 and the gap 31c (the inner through hole 73 and the gaps 33b, 36a) are aligned in the circumferential direction, the second short diffusion oil passage 81′ and the gap 31c communicate via the outer through hole 71, and the second long diffusion oil passage 83′ and the gaps 33b, 36a communicate via the inner through hole 73, as shown in FIG. 18C.

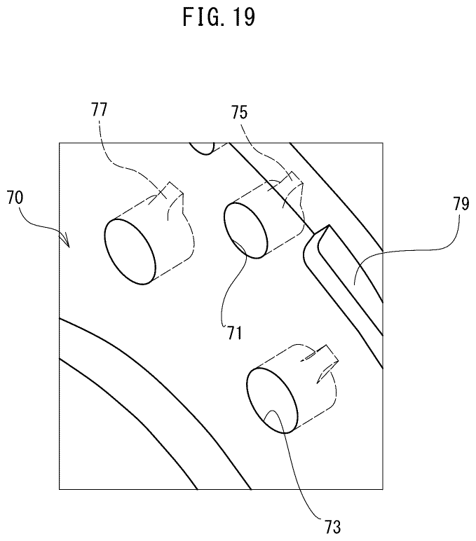

FIG. 19 is a perspective view schematically showing the outer and inner through holes 71, 73. Meanwhile, since the oil flows in the axial direction through the gaps 31c, 33b, 36a, and flows radially outward through the second short diffusion oil passage 81′ and the second long diffusion oil passage 83′, a case is also supposed in which the oil does not change direction smoothly. Therefore, in the rotor structure of this embodiment, the communication grooves 75, 77 having an R-shape when viewed in the circumferential direction are formed in the portion where the second short diffusion oil passage 81′ and the second long diffusion oil passage 83′ communicate with the outer and inner through holes 71, 73. This allows the oil to be smoothly introduced from the gaps 31c, 33b, 36a to the second short diffusion oil passage 81′ and the second long diffusion oil passage 83′.

By forming such second short diffusion oil passage 81′ and second long diffusion oil passage 83′, it becomes possible for the oil that has flowed through the gaps 31c, 33b, 36a to be scattered radially outward from the outer circumferential surface 80c of the fifth end plate 80 by centrifugal force through the second short diffusion oil passage 81′ and the second long diffusion oil passage 83′. In this way, since the fourth and fifth end plates 70, 80 are arranged so as to overlap with the coil end 93b on the output axis side OS when viewed in the radial direction, it is possible to cool the coil end 93b on the output axis side OS, which is one of the cooling target parts.

In addition, the second short diffusion oil passage 81′ and the second long diffusion oil passage 83′ are also formed so that the cross-sectional area increases toward the radially outer side, similar to the first diffusion oil passage 41, so that the second short diffusion oil passage 81′ and the second long diffusion oil passage 83′ can be prevented from being blocked by an oil. This makes it possible to prevent, for example, a phenomenon in which oil even distribution is impaired due to an increase in the amount of an oil flowing through the magnet holes communicating with the second short diffusion oil passage 81′ and the second long diffusion oil passage 83′ where negative pressure is generated.

Here, unlike the coil end 93a on the anti-output axis side AOS, the coil end 93b on the output axis side OS is supplied with an oil after cooling the rotor core 30, etc. (that has been heated to a certain extent), but since the number (24) of the second short diffusion oil passages 81′ and the second long diffusion oil passages 83′ is set to be greater than the number (8) of the first diffusion oil passages 41, in other words, the amount of an oil supplied to the coil end 93b is relatively greater, thus, the coil end 93b can also be cooled efficiently.

In this manner, the oil flow as shown in FIG. 18E, in other words, the portion of the oil flow in the rotor 10 shown in FIG. 4 that corresponds to the rotor core 30 and the fourth and fifth end plates 70, 80, is realized.

In the above rotor structure, the rotor core 30 is sandwiched between the third end plate 60 and the fourth end plate 70 in the axial direction, but because the rotor core 30 is a laminate of stacked magnetic thin plates, a case is also supposed in which an oil flowing in the axial direction inside the rotor core 30 may leak into the gaps between the magnetic thin plates. In this case, it may seem that the leaked oil would have nowhere to escape because it is sandwiched between the third end plate 60 and the fourth end plate 70, but in this embodiment, because the third and fourth end plates 60, 70 have discharge recesses 69, 79 formed therein, the oil that has leaked into the gaps between the magnetic thin plates can be discharged to the outside of the rotor core 30 through the discharge recesses 69, 79.

### Other Embodiments

The present invention is not limited to the embodiments, and can be embodied in various other forms without departing from the spirit or main characteristics thereof.

In the above embodiments, the permanent magnets 101, 102, 103, and 106 and the coil ends 93a and 93b are the parts to be cooled, however, there is no limitation to them, and for example, a separate cooling means may be provided for the coil ends 93a and 93b, and only the permanent magnets 101, 102, 103, and 106 may be cooled.

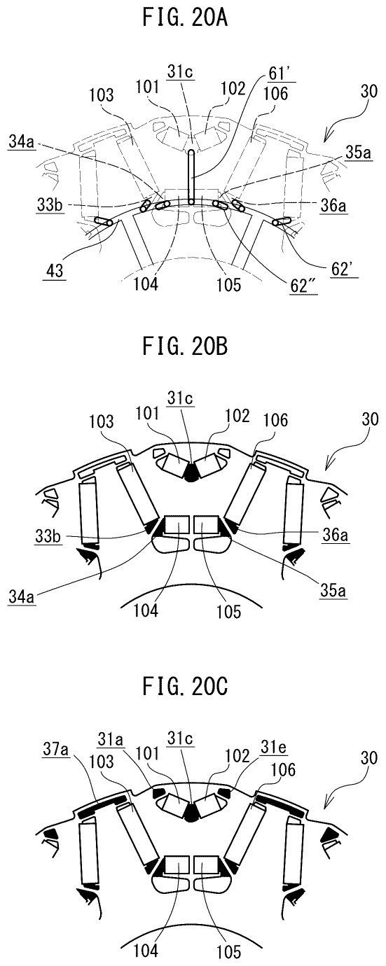

In the above embodiments, four permanent magnets 101, 102, 103, 106 of the six permanent magnets 101, 102, 103, 104, 105, 106 constituting each magnetic pole are targeted for cooling, but this is no limitation to them, and for example, as shown in FIG. 20A, a radial oil passage 62″ communicating with the chamber space 43 may be provided, and an oil may be caused to flow also into the gaps 34a, 35a as shown by the blackened areas in FIG. 20B to target the permanent magnets 104, 105 to be cooled. In addition, as shown by the blackened areas in FIG. 20C, an oil may be caused to flow also into the gaps 31a, 31e, 37a that are not in contact with the permanent magnets 101, 102, 103, 104, 105, 106 to indirectly cool the permanent magnets 103, 106.

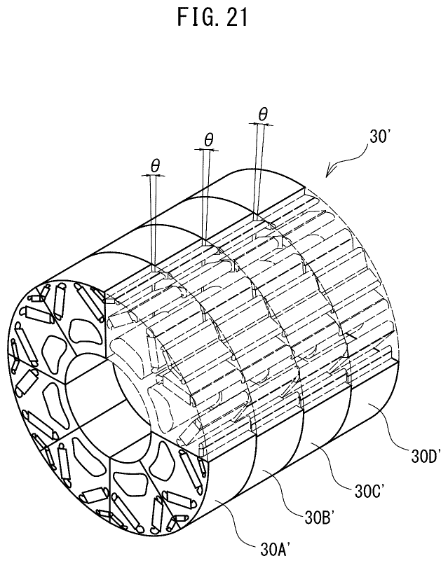

Furthermore, in the above embodiments, the rotor core 30 is so-called skewless, however, there is not limitation to this, and for example, the present invention may be applied to a rotor core 30′ having a skew angle θ, which is formed by combining four laminates 30A′, 30B′, 30C′, and 30D′, each of which is made up of a predetermined number of magnetic thin plates stacked in the axial direction, with each laminate being shifted by an angle θ, as shown in FIG. 21.

In addition, in the above embodiments, the number of oil discharge holes 29, connecting flow paths 45, first diffusion oil passages 41, first radial oil passages 61′, second short diffusion oil passages 81′, etc. is eight, and the number of second radial oil passages 62′, second long diffusion oil passages 83′, etc. is sixteen, but there is no limitation to them, and these numbers may be set appropriately.

Furthermore, in the above embodiments, the rotor 10 has eight magnetic poles, but this is no limitation to this, and the number of magnetic poles may be less than eight, or may be more than eight.

In addition, in the above embodiments, each magnetic pole has a two-layer structure with an outer embedded magnet section 100A arranged in a V-shape on the radially outer side and an inner embedded magnet section 100B arranged in a U-shape on the radially inner side, but this is no limitation to this, and it may also have a single-layer structure with outer embedded magnet sections arranged in a V-shape or a straight line, for example.

Furthermore, in the above embodiments, the end plates on the anti-output axis side AOS are made up of the first to third end plates 40, 50, 60, and the end plates on the output axis side OS are made up of the fourth and fifth end plates 70, 80, however, there is not limitation to this, and for example, the end plates on the anti-output axis side AOS and the output axis side OS may each be made from a single member, using a sand mold for casting.

As mentioned above, the above-described embodiments are merely illustrative in all respects and should not be construed as limiting. Furthermore, all modifications and variations within the scope of the claims are within the scope of the present invention.

Although the present disclosure has been described based on examples, it is understood that the present disclosure is not limited to the examples or structures. The present disclosure also includes various modifications and variation within the equivalent range. In addition, various combinations and forms, and other combinations and forms including only one element, more than one element, or less than one element, are also within the scope and concept of the present disclosure.

### INDUSTRIAL APPLICABILITY

According to the present invention, the parts to be cooled inside a synchronous motor can be efficiently cooled, and therefore, it is extremely beneficial when applied to the rotor structure of a synchronous motor.

What is claimed is:

1. A rotor structure that supplies an oil to a cooling target part inside a synchronous motor in which a rotor rotates in synchronization with a rotating magnetic field generated by a stator, characterized by being configured such that:
the rotor comprises a plurality of permanent magnets, which are one of the cooling target parts, and a cylindrical rotor core in which a plurality of axially extending magnet holes are formed in which the respective permanent magnets are embedded, and
an oil flows axially inside the rotor core through the plurality of magnet holes.

2. The rotor structure according to claim 1, characterized by being configured such that:
the rotor further comprises a rotor shaft that is inserted into the rotor core so as not to rotate relative to the rotor core, and an annular one-side end plate that is attached concentrically with an axis center of the rotor core to the end on one axial side of the rotor core,
the one-side end plate has a chamber space formed having an annular shape as viewed in the axial direction concentrically with the axis center of the rotor core, and
at the one-side end plate, an oil is filled into the chamber space from an oil passage in the rotor shaft and the oil is distributed from the chamber space to the plurality of magnet holes.

3. The rotor structure according to claim 2, characterized in that:
the one-side end plate has a plurality of radial oil passages formed that extend radially on an other axial side than the chamber space, whose radially inner end communicates with the chamber space, and whose radially outer end communicates with a plurality of the magnet holes, and
in each of the radial oil passages, a surface that defines the radial oil passage on one axial side and a surface that defines the radial oil passage on the radially outer side are connected in an R-shape when viewed in a circumferential direction.

4. The rotor structure according to claim 2, characterized in that:
the one-side end plate has a plurality of radial oil passages formed that extend radially on an other axial side than the chamber space, whose radially inner end communicates with the chamber space, and whose radially outer end communicates with a plurality of the magnet holes, and
the radially outer end of each of the radial oil passages is in communication with a radially inner portion of each of the magnet holes.

5. The rotor structure according to claim 2, characterized in that:
the one-side end plate is disposed so as to overlap, as viewed in a radial direction, a coil end on one axial side, which is one of the cooling target parts, of a stator coil attached to the stator,
the one-side end plate has a plurality of first diffusion oil passages formed that extend radially on one axial side than the chamber space, whose radially inner end communicates with the chamber space, and that open on an outer peripheral surface of the one-side end plate, and
each of the first diffusion oil passages is formed so that its cross-sectional area increases toward the radially outer side.

6. The rotor structure according to claim 5, characterized in that:
the rotor further comprises an annular other-side end plate attached concentric with the axis center of the rotor core to the end on an other axial side of the rotor core,
the other-side end plate is disposed so as to overlap, as viewed in a radial direction, the coil end on the other axial side, which is one of the cooling target parts, of the stator coil,
the other-side end plate has a plurality of second diffusion oil passages formed that extend radially, whose radially inner end communicates with a plurality of the magnet holes, that open on the outer peripheral surface of the other end plate, and whose cross-sectional area increases toward the radially outer side, and
a number of the second diffusion oil passages is set to be greater than a number of the first diffusion oil passages.

7. The rotor structure according to claim 1, characterized in that:
the rotor core has a skew angle of 0 degrees.
